(19) United States
(12) Patent Application Publication
(10) Pub. No.: US 2025/0303448 A1
(43) Pub. Date: Oct. 2, 2025

(54) TROMMEL WITH ELONGATED SLOTS FOR PLASTICS SEPARATION

(71) Applicant: Thomas Valerio, Atlanta, GA (US)

(72) Inventor: Thomas Valerio, Atlanta, GA (US)

(21) Appl. No.: 19/239,231

(22) Filed: Jun. 16, 2025

Related U.S. Application Data
(63) Continuation of application No. PCT/US23/84004, filed on Dec. 14, 2023.
(60) Provisional application No. 63/432,634, filed on Dec. 14, 2022.

(51) Int. Cl. B07B 1/22; B07B 1/46; B07B 1/52

(52) U.S. Cl. CPC B07B 1/22; B07B 1/4609; B07B 1/522; B07B 2220/02

(57) ABSTRACT

A trommel apparatus has a cylindrical body configured for rotational movement and a plurality of elongated holes or slots formed in the cylindrical body. The trommel apparatus can be used to sort pieces of automobile shredder residue.

### STATEMENT OF RELATED PATENT APPLICATIONS

This application is a continuation of International Patent Application No. PCT/US2023/84004, filed on Dec. 14, 2023, which benefit of U.S. Provisional Patent Application No. 63/432,634, filed Dec. 14, 2023, which is incorporated by reference herein in its entirety.

### TECHNICAL FIELD

This application relates to separation equipment.

### BACKGROUND

A trommel screen, or rotary screen, is a mechanical device used for separating materials, predominantly in mineral and solid-waste processing industries. It features a perforated cylindrical drum, usually angled at the feed end. Material separation occurs as the feed spirals down the rotating drum, with smaller particles passing through the screen apertures, while larger particles exit at the opposite end.

While trommel screens are not commonly associated with plastic products, they are extensively used in municipal waste management for sorting solid waste by size. They also enhance the recovery of fuel from solid waste by removing inorganic materials like moisture and ash from air-classified light fractions of shredded solid waste, thereby improving fuel quality. Additionally, trommel screens find applications in wastewater treatment, where they facilitate the separation of solids from liquid flows. The screens rotate when the liquid reaches a set level, with solids accumulating on the screen mesh and being conveyed for further processing.

The screens in trommels are typically made from perforated plates or mesh. Perforated plate screens, made by rolling and welding, offer strength and fewer ridges, easing the cleaning process. Conversely, mesh screens, while replaceable and more prone to wear and tear, require more intensive cleaning due to objects getting lodged in the mesh ridges. The screens are typically uniformly shaped or irregularly shaped, which is not helpful for plastics separation.

Accordingly, there is always a need for an improved trommel.

### SUMMARY

This application discloses a trommel apparatus having a cylindrical body configured for rotational movement; and a plurality of elongated holes or slots formed in the cylindrical body.

One aspect is a trommel apparatus having a cylindrical body configured for rotational movement; and a plurality of elongated holes or slots formed in the cylindrical body. The elongated holes or slots can be oriented longitudinally along the axis of the cylindrical body. The elongated holes or slots can have a length-to-width ratio greater than 3:1 greater than 4:1, or greater than 6:1. The elongated holes or slots can be arranged in a helical pattern along the cylindrical body. The edges of the elongated holes or slots can be reinforced.

Another aspect includes a method of separating materials using a trommel with elongated slots. The method can include providing a trommel apparatus a cylindrical body configured for rotational movement; and a plurality of elongated holes or slots formed in the cylindrical body; providing material having plastics into rotating the cylindrical body; introducing material into the rotating cylindrical body; and allowing smaller materials to exit the cylindrical body through the elongated holes or slots. The material has plastics or may be automobile shredder residue.

### BRIEF DESCRIPTION OF THE FIGURES

FIG. 1 is a perspective view of one embodiment of a trommel, featuring a cylinder with elongated slots, as described in this application;

FIG. 2 is a perspective view of the cylinder as depicted in FIG. 1;

FIG. 3 is a perspective view of a section of the cylinder shown in FIG. 2; and

FIG. 4 is an illustrative diagram showing a method relevant to this application.

### DETAILED DESCRIPTION

This application describes specific embodiments of a trommel designed for sorting, grading, and separating various sizes of mixed solids (having substantial plastics) in numerous applications. The device can have a rotating drum or cylinder, which is equipped with circumferentially arranged, elongated bars or slots. These bars are spaced to allow objects of desired sizes to pass through for collection. In essence, the trommel or trommel apparatus described here is a cylindrical screening device, primarily used for separating materials containing significant amounts of plastics. The incorporation of elongated slots in the trommel or trommel apparatus design serves to improve the efficiency and precision of the material separation process.

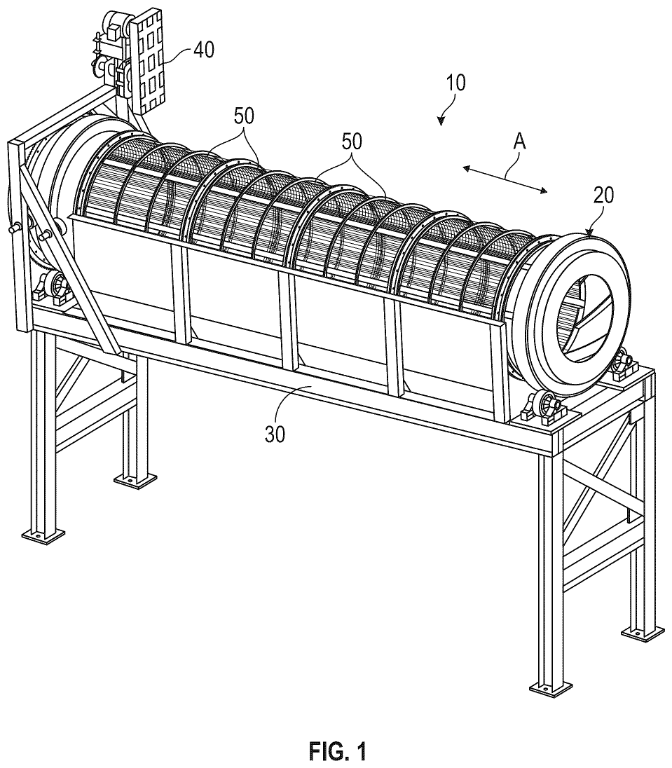

FIG. 1 shows the trommel or trommel apparatus (10) consists of a cylindrical body (20), typically constructed from durable metals like steel or aluminum. The cylinder resides in frame (30), The cylinder's length and diameter can vary based on the intended use and capacity requirements. The surface of the cylindrical body (20) has screens (50) with elongated slots. These slots are oriented longitudinally, parallel to the trommel's axis (A). The length-to-width ratio of the slots is optimized to help ensure effective sorting of materials while minimizing blockages. The edges of the slots or bars or the screen (50) can be reinforced to withstand wear and tear.

A drive motor (not shown) rotates the cylinder body (20) by virtue of the shaft operatively connected to the drum, which may be control by an interface or switch (40). The trommel or trommel apparatus (10) is mounted on a horizontal axis and is powered by an external motor. This motor facilitates the rotational movement of the trommel or trommel apparatus, essential for the screening process. The speed of rotation can be adjusted according to the material being processed.

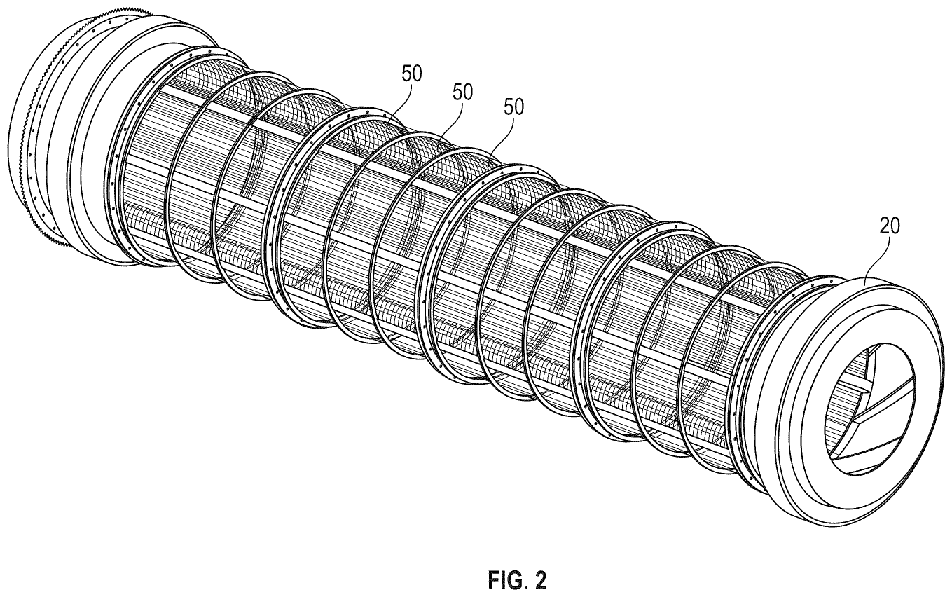

FIG. 2 presents a perspective view of a cylinder body (20) equipped with screens (50). These screens, based on their mesh spacing, are designed to allow the passage of plastic solids of a specific size. To prevent or reduce mesh plugging and minimize downtime, a brush can be applied to the screens. In certain embodiments, these screens feature elongated slots that enable flat materials of certain dimensions to pass through them.

In this example, the sorting device, or trommel or trommel apparatus (10), features a drum with elongated slots spaced at various distances (e.g., approximately 3, 4, 6, 8, 10, 12 inches, or more). These slots are designed to selectively allow flat particles to pass through. The trommel or trommel apparatus (10) retains larger, three-dimensional or less flat particles on top of the screen while sorting out the flatter ones. Despite being larger in size, these flat particles can pass through the slots due to their minimal thickness compared to their other two dimensions. The trommel-style sorter is engineered to utilize centrifugal force or lifters. These mechanisms lift the particles, causing them to fall onto the slotted screen deck repeatedly. This repeated reorientation enhances the chances of flat particles aligning vertically, allowing them to pass through the slots in their flat orientation.

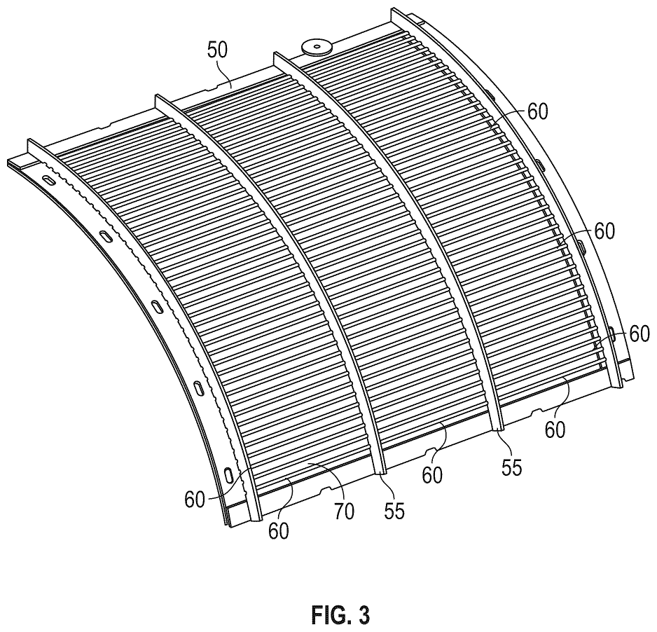

FIG. 3 illustrates an example of a screen (50) designed to be mounted on the cylinder body (20). This figure highlights how bars (60) are utilized to form slots, each with specific width and length dimensions. Additionally, the screen (50) may include reinforcements (55) for added stability and durability. The slot (70) is depicted as the space between the bars (60).

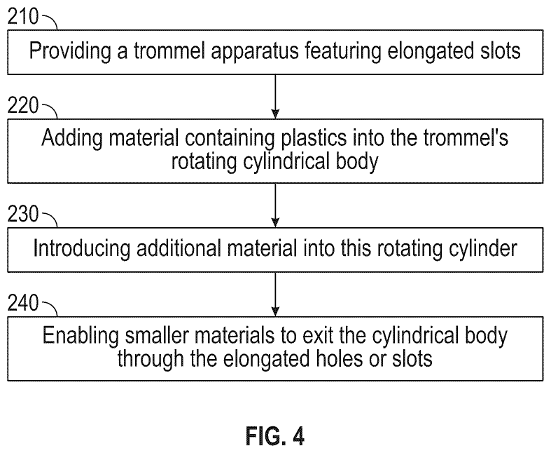

FIG. 4 depicts method 200 for recycling waste material using a trommel equipped with elongated slots. The method comprises the following steps: firstly, providing a trommel apparatus featuring elongated slots (210); secondly, adding material containing plastics into the trommel's rotating cylindrical body (220); thirdly, introducing additional material into this rotating cylinder (230); and finally, enabling smaller materials to exit the cylindrical body through the elongated holes or slots (240).

In its operation and use, the trommel or trommel apparatus can be effective in sorting lightweight materials, particularly plastics. Materials are introduced into the higher end of the trommel or trommel apparatus. As it rotates, smaller particles are able to fall through the elongated slots, thus being separated from larger items. The sorted materials are then collected either at the trommel's lower end or via conveyors situated below the slots. Specifically, flexible materials like rubber pass through, while three-dimensional objects such as rubber hoses, tire rubber, wood, etc., are filtered out. The incorporation of elongated slots brings several benefits, such as improved sorting precision, decreased likelihood of clogging, and increased processing capacity. Additionally, the design is adept at handling a diverse array of materials, including those that are moist or sticky. An important application of this sorter is in separating plastics from waste material.

In one embodiment, the processes and systems were found to be highly effective in recovering plastics from waste material that was aspirated waste, which is common in the European Union from processes that do not involve incineration. Aspirators are well known in the classifying art and result in a light fraction having organic material with limited amounts of metal and such metal tends to be buried/embedded/entangled with the organic fibers. Often, the fibrous feedstock has buried, embedded, or entangled plastic therein.

The waste material may have less than 60%, 50%, 40%, 30%, 20%, 10%, 6%, 5%, 4%, 3%, 2%, or 1% of plastics by weight or volume. In some examples, the fibrous light material contains greater than 95% plastics or organics. In some examples, plastic material makes up more than 90% of the waste material after the large, 3-dimensional objections (un-shredded material or large objects greater than 5 or 6 mm).

With regards to the waste stream, specific embodiments can be used to process waste materials or recyclable material that contains a concentration of plastics larger than 15%, or 25%, 35%, 45%, and/or 50%. This means that as long as there is a good concentration of plastics (as low as 20% or larger) the system can properly sort the materials. Household waste that has been presorted into “plastic and non-plastic” streams will be a good example. Typically, household waste that is not landfilled can be presorted at a recycling facility where plastics separation will be generated. This plastics concentrate is one example of a “good feed material.” Municipal waste containing plastics is an exemplary waste stream material.

In one embodiment, the feed material can be automobile shredder residue (ASR). Automotive Shredder Residue (ASR), typically constituting 15-25% of a vehicle's mass at its end-of-life stage (post being an End of Life Vehicle or ELV), is the residual material remaining after processes such as de-pollution, dismantling, shredding of the vehicle's body, and the extraction of metals. ASR can be segmented into three categories: ‘light fluff’, ‘heavy fluff, and a mineral fraction. Both light and heavy fluff are distinguished by their high concentration of combustible materials, including plastics, rubber, and textiles.

FIG. 1 and FIG. 2 illustrate an exemplary trommel-sorter featuring slots with bars running along the trommel's length, supported by circumferential rings. The slot widths in various embodiments may range from a quarter-inch to an inch, or any increment within this range. Slot lengths vary between 3 inches and 24 inches, with options for increments within this range. These dimensions are carefully chosen to optimize plastic recovery from waste streams. In some designs, the longer dimension of the slots is 2 to 8 times larger than the size of the plastic pieces being sorted. In one example, the longer dimension can be 2-8, 3, 4, 5, 6, 7 or 8 times the size of the plastic drops.

The different elements or parts of the module is constructed using different materials of construction like stainless steel, mild steels etc.

As can be see, the trommel or trommel apparatus can be optimized in various ways. For example, the size of the elongated slots can be adjusted to suit specific material sizes. Additional features like brushes or scrapers can be added to keep the slots clear. Further, the trommel or trommel apparatus can be designed to be portable or stationary, depending on the application.

Although specific embodiments of the disclosure have been described above in detail, the description is merely for purposes of illustration. It is to be understood that the present description illustrates those aspects of the invention relevant to a clear understanding of the invention. Certain aspects of the invention that would be apparent to those of ordinary skill in the art and that, therefore, would not facilitate a better understanding of the invention have not been presented in order to simplify the present description. Although embodiments of the present invention have been described, one of ordinary skill in the art will, upon considering the foregoing description, recognize that many modifications and variations of the invention may be employed. All such variations and modifications of the invention are intended to be covered by the foregoing description.

What is claimed:

1. A trommel apparatus comprising:
a) a generally cylindrical drum having an inlet end, an outlet end and a longitudinal axis, the drum being mounted for rotation about the longitudinal axis; and
b) a plurality of elongated apertures formed through a wall of the drum, each elongated aperture extending in a direction having a longitudinal component relative to the longitudinal axis, wherein the plurality of elongated apertures are arranged along a helical path on the drum and the elongated aperture has a width not greater than 1 inch (25 mm).

2. The trommel apparatus of claim 1, wherein each elongated aperture is oriented substantially parallel to the longitudinal axis.

3. The trommel apparatus of claim 1, wherein each elongated aperture has a length-to-width ratio of at least 3:1.

4. The trommel apparatus of claim 3, wherein the length-to-width ratio is at least 4:1.

5. The trommel apparatus of claim 4, wherein the length-to-width ratio is at least 6:1.

6. The trommel apparatus of claim 1, further comprising a cleaning assembly that includes at least one brush biased against an exterior surface of the drum for dislodging material bridging the elongated apertures during rotation.

7. The trommel apparatus of claim 1, further comprising a reinforcement structure bordering perimeter edges of the elongated apertures.

8. The trommel apparatus of claim 1, wherein each elongated aperture has a width of at least 0.75 inch (19 mm).

9. A method of classifying a particulate feed material, the method comprising:
a) providing the trommel apparatus of claim 1;
b) rotating the drum about the longitudinal axis;
c) introducing the feed material into the drum through the inlet end; and
d) operating the cleaning assembly while the drum rotates to remove lodged material from the elongated apertures; and
e) permitting a fines fraction of the feed material to pass outwardly through the elongated apertures while an oversize fraction is retained until it exits through the outlet end.

10. The method of claim 9, wherein the feed material comprises plastic materials.

11. The method of claim 10, wherein the feed material comprises automobile shredder residue.

12. A trommel screening system comprising:
a) a frame;
b) a generally cylindrical drum mounted on the frame for rotation about a longitudinal axis, the drum defining a plurality of elongated apertures oriented longitudinally relative to the axis, each elongated aperture having a length-to-width ratio of at least 3:1;
c) a drive motor operatively coupled to the drum to rotate the drum; and
d) a cleaning assembly comprising at least one brush biased against an exterior surface of the drum for dislodging material bridging the elongated apertures during rotation.

13. The trommel screening system of claim 12, wherein the elongated apertures are arranged in a helical pattern on the drum.

14. The trommel screening system of claim 12, further comprising a plurality of circumferential reinforcing rings coupled to the drum.

15. The trommel screening system of claim 12, wherein the cleaning assembly is repositionable along an axial length of the drum.

16. The trommel screening system of claim 12, further comprising a controller configured to vary a rotational speed of the drum between 5 rpm and 25 rpm.

17. The trommel screening system of claim 12, wherein the drum is mounted at an angle of between 3 degrees and 8 degrees relative to horizontal.

18. The trommel screening system of claim 12, wherein the elongated apertures are defined by parallel bars spaced between 0.25 inch and 1 inch apart.

19. The trommel screening system of claim 12, wherein a length of each elongated aperture is between two and eight times a maximum dimension of a plastic article intended to pass therethrough.

20. The trommel screening system of claim 12, wherein at least one of the drum, the frame, or the bars forming the elongated apertures is fabricated from stainless steel.
